(19) United States
(12) Patent Application Publication
(10) Pub. No.: US 2024/0216933 A1
(43) Pub. Date: Jul. 4, 2024

(54) FLUID IONISING DEVICE

(71) Applicant: Corryn Biotechnologies Limited, Cardiff (GB)

(72) Inventor: Luke Burke, Swansea (GB)

(73) Assignee: Corryn Biotechnologies Limited, Cardiff (GB)

(21) Appl. No.: 18/558,459

(22) PCT Filed: Aug. 17, 2022
(86) PCT No.: PCT/EP22/72923

§ 371 Date: Nov. 1, 2023

(30) Foreign Application Priority Data
Aug. 19, 2021 (GB) 2111883.1

(51) Int. Cl. B05B 5/025; B05B 5/16; D01D 5/00

(52) U.S. Cl. CPC B05B 5/0255; B05B 5/1608; D01D 5/0069

(57) ABSTRACT

The invention relates to a device for electro spraying or electro spinning wherein said device comprises a chamber for housing a fluid to be electro spun or electro sprayed, characterized in that, said chamber also includes at least one electrically conducting member situated in and/or about said fluid in said chamber or at least one movable electrically conducting member that can be positioned at least partially in said fluid in said chamber when the fluid is to be charged; further the invention also relates to a dispensing device adapted to accommodate said device and a method of electro spraying or electro spinning using said device or said dispenser.

### FIELD OF THE INVENTION

The invention relates to a device for electro spraying or electro spinning wherein said device comprises a chamber for housing a fluid to be electro spun or electro sprayed, characterized in that, said chamber also includes at least one electrically conducting member situated in and/or about said fluid in said chamber or at least one movable electrically conducting member that can be positioned at least partially in said fluid in said chamber when the fluid is to be charged; further the invention also relates to a dispensing device adapted to accommodate said device and a method of electro spraying or electro spinning using said device or said dispenser.

### BACKGROUND OF THE INVENTION

Electrohydrodynamic (EHD) jetting, or printing, is a high-resolution technique where an electrically conductive or polarizable liquid is driven or deposited on a substrate, essentially, by an electric field. Exposure of an electrically conductive or polarizable liquid to an electric field causes mobile ions in the liquid to accumulate at the liquid surface. The shape of the liquid starts to deform from the shape caused by surface tension alone. As the voltage is increased the effect of the electric field becomes more prominent. As the effect of the electric field begins to exert a similar magnitude of force on the droplet as the surface tension does, a cone shape begins to form with convex sides and a rounded tip, called a Taylor cone. When the electric field exceeds a critical threshold limit, the stress from the electrostatic charge repulsion at the cone apex exceeds the surface tension and a droplet of fluid is emitted. The droplet then begins to stretch and, at a critical point, a stream of liquid erupts from the surface. This is called a cone-jet and is the beginning of the electro spraying process in which ions transition into the gas phase. It is generally found that, in order to achieve a stable cone-jet, a slightly higher than threshold voltage must be used.

Similarly, to standard electro spraying, electrospinning is a fiber production method which uses electric force to draw charged threads of polymer solutions or polymer melts up to fiber diameters, in the order of some hundred nanometers. Electrospinning shares characteristics of both electro spraying and conventional solution dry spinning of fibers. The application of high voltage to a polymer solution can result in the formation of a cone-jet geometry and if the molecular cohesion of the liquid is sufficiently high, stream breakup does not occur (if it does, droplets are electro sprayed) and a charged liquid jet is formed. As the jet dries during flight, the jet is then elongated by a whipping process caused by electrostatic repulsion initiated at small bends in the fiber. The elongation and thinning of the fiber resulting from this bending instability leads to the formation of uniform fibers with nanometer-scale diameters.

Both electro spraying and electrospinning have numerous uses, including the manufacture of filter medium and capture materials, textile manufacturing, cosmetic nanomaterial manufacture, surface preparation for biological catalysis, and generation of long fiber composite materials.

In addition, significant research in the clinical and medical sectors has been undertaken, with the use of electro spun scaffolds for tissue engineering applications where these scaffolds have been penetrated with cells to treat or replace biological targets. Nanofibrous wound dressings have excellent capability to isolate the wound from microbial infections. Other medical textile materials such as sutures are also attainable via electrospinning. Through the addition of a drug substance into the electrospinning solution or melt, diverse fibrous drug delivery systems (e.g., implants, transdermal patches, oral forms) can be prepared. Electrospinning is being investigated as a technique for cost-effective, easy to manufacture wound dressings, medical implants, and scaffolds for the production of artificial human tissues. These scaffolds fulfil a similar purpose to the extracellular matrix in natural tissue. Biodegradable polymers, such as polycaprolactone, are typically used for this purpose. These fibers may be coated with collagen to promote cell attachment, although collagen has successfully been spun directly into membrane

Electrohydrodynamic jetting techniques, such as electrospinning, are well known in the art having an established use in the research and laboratory environment. The standard laboratory setup for electrospinning consists of a spinneret (typically a hypodermic syringe needle) connected to a high-voltage (5 to 50 kV) direct current power supply, a syringe pump, and a grounded collector. A polymer solution, sol-gel, particulate suspension or melt is loaded into the syringe and this liquid is extruded from the needle tip at a constant rate by a syringe pump. However, this technique has limited utility in the field and clinical based set ups.

In view of this, numerous attempts have been made to develop portable EHD and electrospinning devices.

WO/2010/059127 discloses a portable electrospinning apparatus for generating fibers comprising at least one reservoir for holding at least one electrospinning medium, an outlet for dispensing the electro spun fibers, a grounded electrode for contacting a surface onto which the fibers are deposited, and a hollow elongate device adapted to connect to the outlet, the hollow elongate device being capable of directing the dispensed fibers in a pre-determined direction.

U.S. Pat. No. 7,794,219 discloses an electrospinning device for generating a coat from a liquefied polymer. The device comprises a dispenser for dispensing the liquefied polymer a cavity having a longitudinal axis, comprising a first system of electrodes, the dispenser and the first system of electrodes being constructed and design such that the liquefied polymer is dispensed from the dispenser and forms a plurality of polymer fibers moving along the longitudinal axis, and a mechanism for relocating the polymer fibers out of the cavity towards an object so as to generate a coat on the object.

WO2016075688 discloses a device comprising a housing configured to be held by a user, a container accommodating an electrospinning medium, a nozzle in fluid communication with the container a mechanism for dispensing said medium from said container via said nozzle, an auxiliary electrode surrounding said nozzle, and a power supply providing electric potentials to said nozzle and auxiliary electrode. It is taught that electrospinning is characterized by establishing a closed electric circuit including an air span between a high voltage electrode and surface to be coated (e.g. skin), where an electric current arises within the air span.

However, in all the above examples of the prior art portable nozzle-based electrospinning devices, each configuration suffers from the same significant drawback wherein the significant electric potential can lead to charge leakage and the possibility of a sudden discharge if touched by the user. As such, electrospinning systems must be contained in housings thus limiting their clinical utility. In addition to safety considerations when working with sudden high-voltage discharges, the current that may be lost due to such discharge events can lead to considerable variations in in polymer spinning or spray performance, and so performance of the technique.

Accordingly, we herein disclose an alternative a portable device for Electrohydrodynamic (EHD) jetting comprising a fluid/polymer reservoir that is directly charged and an associated non-conductive aperture/channel for delivery of the charged fluid to a nozzle. In this arrangement, the device can be contacted with the skin without exhibiting any discharge or electrical sensation, even when in close contact to metallic, electrically grounded surfaces. This advantageous arrangement, in addition to improved safety, also provides for more consistent electrospinning/electro spraying performance as charge leakage to humid exterior environments is less pronounced.

### Statements of Invention

According to a first aspect of the invention there is provided a device for electro spraying or electro spinning wherein said device comprises a chamber for housing a fluid to be electro spun or electro sprayed, said chamber comprising:
i) a non-conductive outlet through which said fluid is dispensed; and
ii) an associated drive mechanism for ensuring said fluid is moved towards said outlet;
   characterized in that said chamber also includes at least one electrically conducting member situated in and/or about said fluid in said chamber or at least one movable electrically conducting member that can be at least partially positioned in said fluid in said chamber when the fluid is to be charged.

In a preferred embodiment of the invention said non-conductive outlet is a nozzle.

In preferred embodiments of the invention said fluid is selected from any range of aqueous suspensions, emulsions or solutions, that are electrically conductive and ideally viscous, where the degree of viscosity is inversely related to its conductivity, thus, very viscous solutions will have to be more electrically conductive to electrospray/spin, whereas less viscous fluids can be less conductive yet still electrospray/spin.

Examples of suitable organic suspensions emulsions or solvents include, without limitation, collagen, gelatin, poly(caprolactone) (PCL), polycarbonate (PC), polyethylene terephthalate (PET), poly(etherehterketone) (PEEK), Poly(vinyl chloride) (PVC) and polyurethane (PU).

Examples of suitable water-based suspensions emulsions or solvents include, without limitation, Poly(vinyl alcohol) (PVA) poly(ethylene oxide) (PEO/PEG), poly(vinylpyrrolidone) (PVP), poly(acrylic acid) (PAA) and poly(acrylamide) (PAM).

Example of naturally occurring polymer-based suspensions emulsions or solvents include, without limitation, cellulose, cellulose acetate, ethyl cellulose, chitin, chitosan, fibroin, dextran and sodium alginate.

Yet more preferably said drive mechanism is in the form of a plunger and more ideally still, said chamber is sized and shaped to accommodate said plunger. Most ideally, said chamber is in the form of a syringe with a non-conductive outlet or nozzle.

In certain embodiments of the invention said device is fashioned for laboratory or clinical use and may comprise a disposable device. In the alternative, the device of the invention may be fashioned for large scale industrial use.

In a preferred embodiment of the invention the nozzle diameter is ideally less than 5/16″ diameter or aperture, and lower size that is limited only by fluid viscosity.

In yet a further preferred embodiment of the invention said chamber has a wall including an aperture through which said movable electrically conducting member can be inserted. Most preferably, according to one embodiment, said aperture and said movable electrically conducting member are sized and shaped to ensure fluid is unable to leak from said chamber when the two engage, for example, by ensuring a functional but suitable frictional grip.

In yet a further preferred embodiment, said aperture in said wall is aligned with a part of the chamber which is proximal to, but spaced from, said nozzle and so represents a part of the chamber that is upstream of said nozzle.

Yet more preferably still, said aperture in said wall is provided by at least one, and ideally two or more, apertured and aligned sheets whereby the aperture in each sheet sits next to the aperture in an adjacent sheet. Ideally each aperture is designed to accommodate said movable conducting member. Notably the size or thickness of the each of said sheet and the size of the aperture may be customized to a user's requirements, the only stipulation being the electrically conducting member has to be large enough to charge fluid in the reservoir prior to it being dispensed.

In a yet further preferred embodiment, said sheet(s) of the wall is made from a different material to the rest of the chamber and its nozzle, in that, the chamber generally and the nozzle is non-conductive, and the sheet part conductive. In this manner, the movable conductive member can charge the fluid by making contact with the sheet(s) which thereby charge the fluid in one embodiment, or by direct contact with the fluid by way of the aperture.

In yet an alternative embodiment of the invention the inner part of the chamber wall i.e. the part that makes contact with the fluid is conductive, and extends from the wall comprising the aperture, and so this part represents the electrically conducting member that is about the said fluid. In this manner, the chamber comprises and non-conductive outer surface, and a conductive inner surface, whereby the inner surface is charged by means of the conductive sheet(s).

The important feature of the invention is that the device is manufactured so that the chamber that houses the fluid has a means for charging the body of the fluid contained therein, rather than the fluid being dispensed through a charged nozzle, as in traditional electrospinning.

Yet more preferably, said movable conducting member is in the form of a pin, ideally tensioned using for example a spring or the like whereby once the pin is released the tension of the spring forces the pin into the chamber or into contact with the conductive wall comprising said aperture. As will be appreciated, in this manner said fluid can be charged by direct contact with the conducting member when brought into contact with the fluid, or alternatively, when said contacting member contacts said conductive wall it charges the fluid in contact therewith.

In yet a further embodiment of the invention said chamber is in the form of a cartridge for use in a dispensing device and in this embodiment said tensioned pin is secured to said dispensing device. Accordingly the dispensing device is adapted to accommodate said cartridge in a manner whereby said pin makes mating movable contact with the inside of said chamber and more particularly fluid stored therein.

Accordingly, in a second aspect of the invention, there is provided a dispensing device for electro spraying or electro spinning comprising a chamber for housing a fluid to be electro spun or electro sprayed, said chamber comprising:
i) a non-conductive outlet through which said fluid is dispensed; and
ii) an associated drive mechanism for ensuring said fluid is moved towards said outlet;
   characterized in that, said chamber also includes at least one electrically conducting member situated in and/or about said fluid in said chamber or at least one movable electrically conducting member that can be positioned in said fluid in said chamber when the fluid is to be charged.

According to a third aspect of the invention, there is provided a kit of parts comprising:
at least one cartridge comprising a chamber for housing a fluid to be electro spun or electro sprayed, said chamber comprising:
   i) a non-conductive outlet through which said fluid is dispensed; and
   ii) an associated drive mechanism for ensuring said fluid is moved towards said outlet;
   characterized in that, said chamber also includes at least one electrically conducting member situated in and/or about said fluid in said chamber or at least one movable electrically conducting member that can be positioned in said fluid in said chamber when the fluid is to be charged; and
a dispensing device comprising a tensioned pin, wherein said device is adapted to accommodate the at least one cartridge whereby once the pin is released the tension of the spring forces the pin into the chamber or into contact with the conductive member thereby charging the fluid.

According to a fourth aspect of the invention there is provided a method for electro spraying or electro spinning wherein said method comprises:
i. housing a fluid to be electro spun or electro sprayed in a chamber, said chamber comprising a non-conductive outlet through which said fluid is dispensed and also including at least one electrically conducting member situated in and/or about said fluid in said chamber or at least one movable electrically conducting member that can be positioned in said fluid in said chamber when the fluid is to be charged;
ii. optionally, moving said movable electrically conducting member into said fluid in said chamber when the fluid is to be charged;
iii. charging the electrically conducting member situated in said fluid or positioned in said fluid;
iv. moving said charged fluid through said chamber towards an electrically non-conducting outlet; and
v. dispensing said charged fluid from said electrically non-conducting outlet.

In a preferred method if the invention a handheld embodiment may require about 8 kV and 15 mA, whereas an industrial embodiment may require about 150 kV and 500 mA.

Any of the aforementioned aspects of the invention and an associated drive mechanism for ensuring said fluid is moved towards said outlet may, in preferred embodiments, include or be characterized by any of the aforementioned features pertaining to the device according to the first or second aspects. Thus, preferred features of each aspect of the invention may be as described in connection with any of the other aspects.

In the claims which follow and in the preceding description of the invention, except where the context requires otherwise due to express language or necessary implication, the word “comprises”, or variations such as “comprises” or “comprising” is used in an inclusive sense i.e. to specify the presence of the stated features but not to preclude the presence or addition of further features in various embodiments of the invention.

Preferred features of each aspect of the invention may be as described in connection with any of the other aspects.

Other features of the present invention will become apparent from the following examples. Generally speaking, the invention extends to any novel one, or any novel combination, of the features disclosed in this specification (including the accompanying claims and drawings). Thus, features, integers, characteristics, compounds or chemical moieties described in conjunction with a particular aspect, embodiment or example of the invention are to be understood to be applicable to any other aspect, embodiment or example described herein, unless incompatible therewith.

Moreover, unless stated otherwise, any feature disclosed herein may be replaced by an alternative feature serving the same or a similar purpose.

The present invention will now be described by way of example only with particular reference to the following figures wherein:

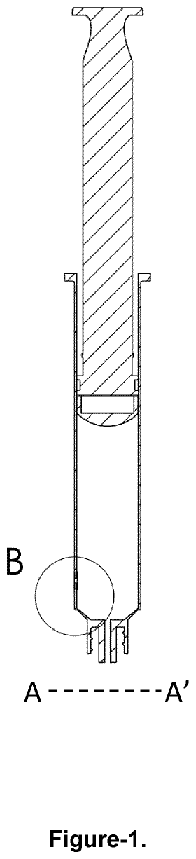

FIG. 1. Shows a side elevated view of a cartridge for use with a dispensing device.

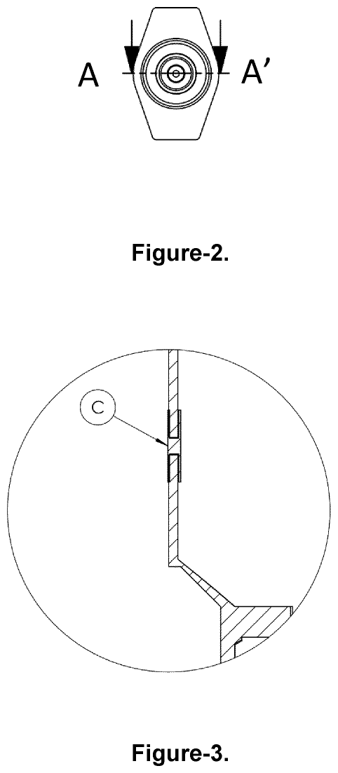

FIG. 2. Shows an end view of the cartridge shown in FIG. 1.

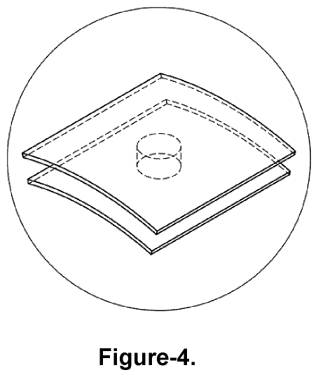

FIG. 3. Shows an expanded view of the wall structure of the cartridge shown in FIG. 1 and labelled B.

FIG. 4. Shows an expanded view of the wall structure of the cartridge shown in FIG. 3 and labelled C.

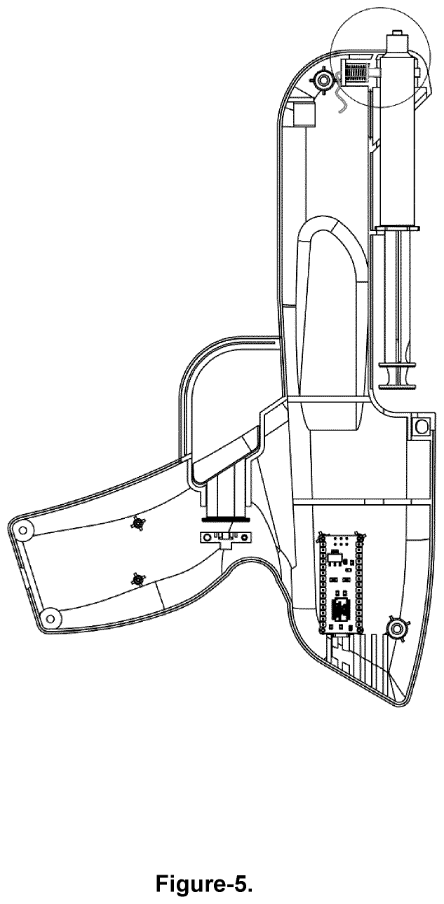

FIG. 5. Shows a side cross-sectional view of a dispensing device housing a cartridge in accordance with FIG. 1.

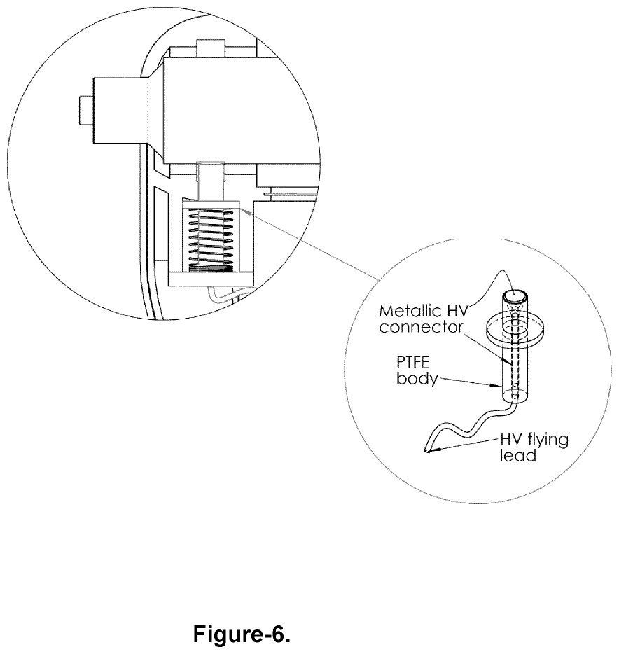

FIG. 6. Shows an expanded view of a part of FIG. 5 i.e., the part housing a movable conducting member in accordance with the invention and also an expanded view of the movable conducting member and the wall structure through which it is inserted.

Referring now to the figures, in FIG. 1 there is shown a cartridge in accordance with the invention, it comprises a conventional syringe, an outlet in the form of a nozzle and an associated plunger, however, notably none of these parts are electrically conducting. As is conventional, the plunger is sized and shaped to fit within the syringe and to slide therein whereby depression of the plunger forces fluid within the chamber part of the syringe to move towards the outlet or nozzle.

As can be seen from FIG. 2 the tip of the non-conducting nozzle is circular in cross section.

In FIG. 3 a wall section of the syringe or chamber is shown towards the tip of the syringe but importantly upstream of the outlet or nozzle so that it is adjacent fluid about to be moved to the tip for dispensing. This wall section comprises at least one and ideally two or more apertured and aligned sheets of material. The aperture in each one of these sheets is sized and shaped to accommodate an electrically conducting pin. This pin is shown in FIG. 5 where it is attached, under tension, using a spring, to a dispensing device but, in use, aligned with the aperture in the wall of the syringe. This arrangement ensures, when activated, the tension in the spring forces the pin through the aperture(s) into the chamber and so into the reservoir of fluid contained therein. Alternatively, the sheets may also be conductive in which circumstances the pin when mating with the sheets charges the fluid indirectly by passing electrical current through said sheet forming part of the chamber wall. In all embodiments, the outer surface of the chamber, with the exception of the wall part comprising the aperture, is non-conductive.

In use, the cartridge of FIG. 1 is filled with a fluid to be electro spun or electro sprayed and the plunger is depressed to move fluid towards the non-conducting outlet. The electrically conducting member or pin situated in said fluid in said chamber is charged or the movable electrically conducting member or pin is positioned in said fluid in said chamber and in either case the pin is charged thus transferring charge to the fluid, either by direct contact with the fluid to be spun or sprayed, or through contact with the electrically conductive sheet. Continuous depression of the plunger and maintenance of the charge on the pin results in charged fluid, to be dispensed, being moved towards the pin to be charged and then towards the non-conducting outlet to be dispensed. In this way a charged fluid is dispensed from the device, but electrical discharge is prevented thus making the device safe and fit for purpose.

1. A device for electro spraying or electro spinning wherein said device comprises a chamber for housing a fluid to be electro spun or electro sprayed, said chamber comprising:
i) a non-conductive outlet through which said fluid is dispensed; and
ii) an associated drive mechanism for ensuring said fluid is moved towards said outlet;
characterized in that, said chamber also includes at least one electrically conducting member situated in and/or about said fluid in said chamber or at least one movable electrically conducting member that can be at least partially positioned in said fluid in said chamber when the fluid is to be charged.

2. The device according to claim 1 wherein said non-conductive outlet is a nozzle.

3. The device according to claim 1, wherein said drive mechanism is in the form of a plunger sized and shaped to slide in said chamber.

4. The device according to claim 1, wherein said conducting member is aligned with a part of the chamber which is proximal to, but spaced from, said nozzle and so represents a part of the chamber that is upstream of said nozzle.

5. The device according to claim 1, wherein said chamber has a wall including an aperture through which said movable electrically conducting member can be inserted.

6. The device according to claim 5 wherein said aperture and said movable electrically conducting member are sized and shaped to ensure fluid is unable to leak from said chamber when the two engage.

7. The device according to claim 5, wherein said wall is provided by at least one, and ideally two or more, apertured and aligned sheets whereby the aperture in each sheet sits next to the aperture in an adjacent sheet.

8. The device according to claim 7 wherein each aperture is designed to accommodate said movable conducting member.

9. The device according to claim 7 wherein said sheet(s) of the wall is made from a different material to the rest of the chamber and its nozzle

10. The device according to claim 9 wherein the chamber and the nozzle is non-conductive and the sheet is part conductive.

11. The device according to claim 1 wherein the inner part of the chamber wall i.e. the part that makes contact with the fluid is conductive, and extends from the wall comprising the aperture and the chamber comprises and non-conductive outer surface.

12. The device according to claim 1, wherein said movable conducting member is in the form of a pin.

13. The device according to claim 12 wherein said pin is tensioned whereby once the pin is released the tension forces the pin into the chamber or aperture.

14. The device according to claim 1, wherein said chamber is in the form of a cartridge for use in a dispensing device.

15. The device according to claim 1, wherein the fluid is selected from any range of aqueous suspensions, emulsions or solutions, that are electrically conductive and ideally viscous, where the degree of viscosity is inversely related to its conductivity.

16. The device according to claim 15 wherein the fluid is selected from the group comprising: collagen, gelatin, poly(caprolactone) (PCL), polycarbonate (PC), polyethylene terephthalate (PET), poly(etherehterketone) (PEEK), Poly(vinyl chloride) (PVC) and polyurethane (PU), Poly(vinyl alcohol) (PVA) poly(ethylene oxide) (PEO/PEG), poly(vinylpyrrolidone) (PVP), poly(acrylic acid) (PAA) and poly(acrylamide) (PAM), cellulose, cellulose acetate, ethyl cellulose, chitin, chitosan, fibroin, dextran and sodium alginate.

17. A dispensing device for electro spraying or electro spinning comprising a chamber for housing a fluid to be electro spun or electro sprayed, said chamber comprising:
i) a non-conductive outlet through which said fluid is dispensed; and
ii) an associated drive mechanism for ensuring said fluid is moved towards said outlet;
characterized in that said chamber also includes at least one electrically conducting member situated in and/or about said fluid in said chamber or at least one movable electrically conducting member that can be positioned in said fluid in said chamber when the fluid is to be charged.

18. A kit of parts comprising:
at least one cartridge comprising a chamber for housing a fluid to be electro spun or electro sprayed, said chamber comprising:
a. a non-conductive outlet through which said fluid is dispensed; and
b. an associated drive mechanism for ensuring said fluid is moved towards said outlet;
characterized in that, said chamber also includes at least one electrically conducting member situated in and/or about said fluid in said chamber or at least one movable electrically conducting member that can be positioned in said fluid in said chamber when the fluid is to be charged; and
a dispensing device comprising a tensioned pin, wherein said device is adapted to accommodate the at least one cartridge whereby once the pin is released the tension of the spring forces the pin into the chamber or into contact with the conductive member thereby charging the fluid.

19. A method for electro spraying or electro spinning wherein said method comprises:
i. housing a fluid to be electro spun or electro sprayed in a chamber, said chamber comprising a non-conductive outlet through which said fluid is dispensed and also including at least one electrically conducting member situated in and/or about said fluid in said chamber or at least one movable electrically conducting member that can be positioned in said fluid in said chamber when the fluid is to be charged;
ii. optionally, moving said movable electrically conducting member into said fluid in said chamber when the fluid is to be charged;
iii. charging the electrically conducting member situated in said fluid or positioned in said fluid;
iv. moving said charged fluid through said chamber towards an electrically non-conducting outlet; and
v. dispensing said charged fluid from said electrically non-conducting outlet.
